(19) United States
(12) Patent Application Publication
(10) Pub. No.: US 2004/0226178 A1
(43) Pub. Date: Nov. 18, 2004

(54) Ergonomic handle for a shaving implement

(75) Inventors: Sean Lukan, Milford, CT (US); Thomas A. Follo, Milford, CT (US); Paul R. Dansreau, Shelton, CT (US); David Dombrowski, Madison, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/803,720

(22) Filed: Mar. 18, 2004

Related U.S. Application Data
(60) Provisional application No. 60/458,878, filed on Mar. 28, 2003.

(51) Int. Cl. B26B 21/00

(52) U.S. Cl. 30/526; 30/527

(57) ABSTRACT

An ergonomic handle for a shaving implement includes a head section and a body portion. The body portion has a width and height with the ratio of the width to the height being approximately 1.1 to approximately 1.4 along a length defined by the body portion.

### CROSS-REFERENCE TO RELATED APPLICATIONS

This application is entitled to the benefit of and incorporates by reference essential subject matter disclosed in Provisional Patent Application No. 60/458,878 filed on Mar. 28, 2003.

### FIELD OF THE INVENTION

The present invention is generally directed to shaving implements and relates mare particularly to a handle for a shaving implement, the handle defining parameters that are ergonomically beneficial thereto.

### BACKGROUND OF THE INVENTION

The design of a razor handle for use with a razor system has a large impact on the overall performance of the system. Handle attributes such as length, weight, center of balance and cross sectional shape all contribute to the comfort with which the handle can be held. The challenge in designing such a handle resides in combining style with ergonomics.

Prior handle designs tended to sacrifice ergonomics and comfort for style. On the other hand less expensive razor systems tended to simply employ a straight handle. While being able to accommodate multiple hand positions, these handles were not overly comfortable to use.

Based on the foregoing, it is the general object of the present invention to provide an ergonomic handle that overcomes or improves upon the problems and drawbacks associated with prior art handles.

### SUMMARY OF THE INVENTION

The present invention resides in one aspect in an ergonomic handle for a shaving implement, the handle having a head section and a body portion. The body portion of the handle defines a width and a height with the ratio of the width to the height being about 1.1 to about 1.4 along a length defined by the body portion.

The present invention resides in another aspect in an ergonomic handle for a shaving implement wherein the handle includes a head section and a body portion. The body portion defines a variable width along a length thereof and includes a tip at an end thereof. The largest width defined by the body portion is positioned at a location about 37% of along the length from the tip.

In still another aspect of the present invention, the head section defines an end and the body portion defines a pinch point adjacent to the head section. The pinch point being located about 30 to about 50 mm from the end.

### BRIEF DESCRIPTION OF THE DRAWINGS

FIG. 1 is a plan view of an embodiment of the ergonomic handle of the present invention.

FIG. 2 is a side view of the ergonomic handle of the FIG. 1.

### DETAILED DESCRIPTION OF THE PREFERRED EMBODIMENTS

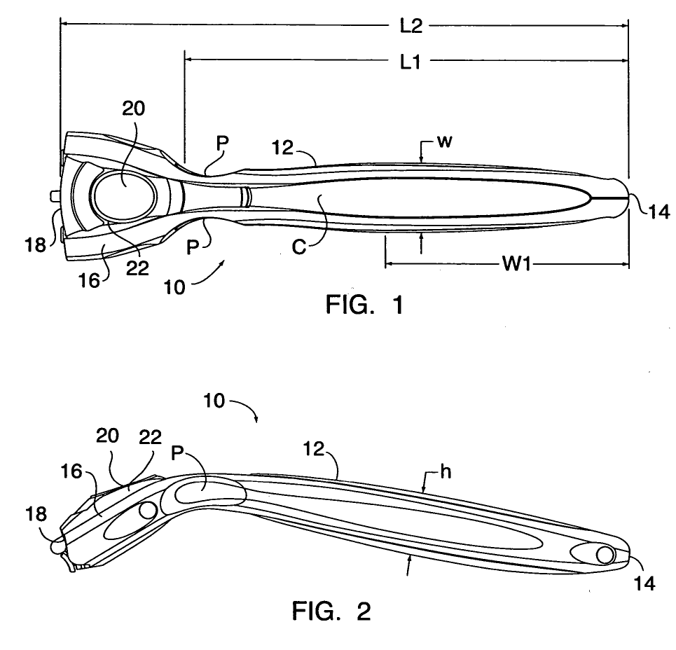

As shown in FIGS. 1 and 2, an ergonomic handle for a shaving implement, generally designated by the reference number 10 includes a body portion 12 that defines a width, indicated by the label “w” and a height, indicated by the label “h”. The ratio of the width “w” to the height “h” is about 1.1 to about 1.4 along a length, indicated by the label “L1” defined by the body portion 12. The width “w” varies along the length L1 with the ratio of the largest to the smallest width preferably being between about 1.3 to about 1.5.

The body portion 12 includes a tip 14 at an end thereof. In the preferred embodiment of the present invention, the largest width defined by the body portion 12 is preferably positioned at a location indicated by the label “w1” about 37% along the length L2 of the handle taken from the tip 14.

The handle 10 defines a pinch point, indicated by the label “P”adapted to be gripped between a user's fingers during a shaving operation. In the preferred embodiment of the present invention, the pinch point “P” is located adjacent to a head section 16 of the handle 10 about 30 to about 50 mm away from an end 18 of the head section.

The handle 10 also defines a center of balance, indicated by the label “C”. The pinch point “P” is located bout 10 to about 25 mm away from the center of balance. The head section 16 of the handle 10 includes a finger rest 20 located on a top portion 22 of said head section. The pinch point “P” is positioned about 15 to about 30 mm away from the finger rest 20.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. An ergonomic handle for a shaving implement comprising:
a handle having a head section and a body portion;
the body portion defining a width and a height with the ratio of the width to the height being about 1.1 to about 1.4 along a length defined by the body portion.

2. An ergonomic handle as defined by claim 1 wherein said width of said body portion varies along said length and the ratio of the largest to the smallest width is about 1.3 to about 1.5.

3. An ergonomic handle as defined by claim 1 wherein said body portion includes a tip at an end thereof, and the largest width defined by said body portion is positioned at a location about 37% of said length from said tip.

4. An ergonomic handle as defined by claim 1 wherein said head section defines an end and said body portion defines a pinch point adjacent to said head section, said pinch point being located about 30 to about 50 mm from said end.

5. An ergonomic handle as defined by claim 1 wherein said handle defines a center of balance and a pinch point, said pinch point being located about 10 to about 25 mm away from said center of balance.

6. An ergonomic handle as defined by claim 1 wherein said handle defines a finger rest on a top portion of said head section, and a pinch point positioned about 15 to about 30 mm away from said finger rest.

7. An ergonomic handle for a shaving implement comprising:
a handle having a head section and a body portion, said body portion defining a variable width along a length thereof; and wherein
said body portion includes a tip at an end thereof, and the largest width defined by said body portion is positioned at a location about 37% of an overall length of said handle.

8. An ergonomic handle as defined by claim 7 wherein the body portion defines a height and the ratio of the width to the height is about 1.1 to about 1.4 along said length.

9. An ergonomic handle as defined by claim 7 wherein said head section defines an end and said body portion defines a pinch point adjacent to said head section, said pinch point being located about 30 to about 50 mm from said end.

10. An ergonomic handle as defined by claim 7 wherein said handle defines a center of balance and a pinch point, said pinch point being located about 10 to about 25 mm away from said center of balance.

11. An ergonomic handle as defined by claim 7 wherein said handle defines a finger rest on a top portion of said head section, and a pinch point positioned about 15 to about 30mm away from said finger rest.

12. An ergonomic handle as defined by claim 7 wherein said width of said body portion varies along said length and the ratio of the largest to the smallest width is about 1.3 to about 1.5.

13. An ergonomic handle for a shaving implement comprising:
a handle having a head section and a body portion, said body portion defining a variable width along a length thereof; and wherein
said head section defines an end and said body portion defines a pinch point adjacent to said head section, said pinch point being located about 30 to about 50 mm from said end.

14. An ergonomic handle as defined by claim 13 wherein the body portion defines a height with the ratio of the width to the height being about 1.1 to about 1.4 along said length.

15. An ergonomic handle as defined by claim 13 wherein said body portion includes a tip at an end thereof, and the largest width defined by said body portion is positioned at a location about 37% of an overall length of said handle from said tip.

16. An ergonomic handle as defined by claim 13 wherein the body portion defines a height and the ratio of the width to the height is about 1.1 to about 1.4 along said from said tip.

17. An ergonomic handle as defined by claim 13 wherein said handle defines a center of balance and a pinch point, said pinch point being located about 10 to about 25 mm away from said center of balance.

18. An ergonomic handle as defined by claim 13 wherein said handle defines a finger rest on a top portion of said head section, and a pinch point positioned about 15 to about 30 mm away from said finger rest.

19. An ergonomic handle as defined by claim 13 wherein said width of said body portion varies along said length and the ratio of the largest to the smallest width is about 1.3 to about 1.5.
